(19) United States
(12) Patent Application Publication
(10) Pub. No.: US 2014/0345131 A1
(43) Pub. Date: Nov. 27, 2014

(54) ELECTRICALLY CONDUCTIVE PIN CONNECTION

(71) Applicant: AIRBUS OPERATIONS GMBH, Hamburg (DE)

(72) Inventors: Guenther STOECKMANN, Ahlersstedt / Wangersen (DE); Wilfried BAUCH, Stockelsdorf (DE); Axel KRANICH, Hamburg (DE); Juergen OTTEN, Tiste (DE)

(21) Appl. No.: 14/297,079

(22) Filed: Jun. 5, 2014

Related U.S. Application Data
(63) Continuation of application No. PCT/EP2012/073215, filed on Nov. 21, 2012.
(60) Provisional application No. 61/569,511, filed on Dec. 12, 2011.

(30) Foreign Application Priority Data
Dec. 12, 2011 (DE) 10 2011 088 300.2

(51) Int. Cl. H01R 4/34; H01R 43/16

(52) U.S. Cl. CPC H01R 4/34; H01R 43/16
USPC 29/876; 439/878

(57) ABSTRACT

The present disclosure relates to an electrically conductive pin connection, including a first electrically conductive contact component which has a first hole, a second electrically conductive contact component which is in contact with the first electrically conductive contact component and which has a second hole, a connecting pin which has a pin head and which is guided through the first and second holes for connecting the first electrically conductive contact component and the second electrically conductive contact component, and a plurality of electrically conductive wires which are arranged in the holes between the edges of the holes and the connecting pin, wherein the electrically conductive wires are bent in such a way that they are clamped between the pin head of the connecting pin and the first electrically conductive contact component.

### CROSS-REFERENCES TO RELATED APPLICATIONS

This application is a continuation of and claims priority to PCT/EP2012/073215 filed Nov. 21, 2012, which claims the benefit of and priority to U.S. Provisional Application No. 61/569,511 filed Dec. 12, 2011, and German Patent Application No. 10 2011 088 300.2 filed Dec. 12, 2011, the entire disclosures of which are herein incorporated by reference.

### TECHNICAL FIELD

The present invention relates to an electrically conductive pin connection, a method for producing a pin connection and an aircraft or spacecraft comprising an electrically conductive pin connection, in particular for highly conductive electrical connections between two or more electrically conductive components.

### BACKGROUND

Bolts, washers and nut connections are used for mechanically connecting electrically conductive components such as metal sheets. If the screw-in connection additionally is to provide electrical conductivity between the electrically conductive components, it is necessary for the elements forming the screw-in connection to be dimensioned and connected in such a way that no electrical points of separation develop, which have increased resistance values and impair the reliability and quality of the electrically conductive screw-in connection.

U.S. Pat. No. 5,453,027 A discloses a washer which is formed for producing an electrically conductive connection between two electrically conductive components having insulating coatings. The washer comprises sharp-edged projections, which penetrate the insulating coatings when used in a screw-in connection, and connects the electrically conductive components.

### SUMMARY

An idea of the present disclosure is to provide a pin connection by means of which the electrically conductive components can be interconnected reliably and with permanently low electrical resistance values.

According to one aspect, the present disclosure provides an electrically conductive pin connection, in particular for connecting electrically conductive components in an aircraft or spacecraft, comprising a first electrically conductive contact component which comprises a first hole, a second electrically conductive contact component which is in contact with the first electrically conductive contact component and which comprises a second hole, a connecting pin which comprises a pin head and which is guided through the first and second holes for connecting the first electrically conductive contact component and the second electrically conductive contact component, and a plurality of electrically conductive wires which are arranged in the holes between the edges of the holes and the connecting pin, wherein the electrically conductive wires are bent in such a way that they are clamped between the pin head of the connecting pin and the first electrically conductive contact component.

According to a further aspect, the present disclosure provides a method for producing a pin connection, comprising the steps of arranging a first electrically conductive contact component, which comprises a first hole, so as to be in contact with a second electrically conductive contact component, which comprises a second hole which is congruent with the first hole, of inserting a plurality of electrically conductive wires into the holes at the edges of the holes, and of guiding a connecting pin, which comprises a pin head, through the first and the second holes for connecting the first electrically conductive contact component and the second electrically conductive contact component, wherein the electrically conductive wires are bent in such a way that they are clamped between the pin head of the connecting pin and the first electrically conductive contact component.

According to a further aspect, the present disclosure provides an aircraft or spacecraft which comprises a pin connection according to the disclosure.

One main idea on which the present invention is based consists in inserting highly conductive wires into a hole, which is provided for a pin connection in two electrically conductive components which are to be screwed together, and in guiding a connecting pin, for example a bolt, through the hole in such a way that the wires are arranged between the outer periphery of the hole and the thread of the connecting pin and are bent between the pin head and one of the electrically conductive components on the outer edge of the hole by means of the pin head.

An advantage of a pin connection of this type is that, by means of the wires, there is extensive contact between the pin head and the electrically conductive component and this equalises any unevenness of the pin head or of the component in the region of the screw connection, and as a result provides a low-resistance pin connection.

A further advantage consists in that the bent wires hermetically seal the interior of the hole against the outside environment, and thereby contaminants from, for example, lubricants or corroding auxiliary substances cannot penetrate the hole. In this way, a gradual loss of conductivity, for example by contact corrosion, oxidation or the penetration of insulating substances such as coating residues or the like, can be permanently prevented.

A further advantage is that the effects of settling processes in the components or the elements forming the pin connection or of expansion processes by mechanical loading or variations in temperature, which can cause loose contacts, are reduced in such a way that the probability of the pin connection failing can be lowered.

As a result, the cost of testing and repair can be lowered when using the pin connection according to the invention, and safety standards, for example in the case of functionally critical electrical connections such as earthing contacts, are more closely adhered to.

According to an embodiment of the pin connection according to the disclosure, the pin connection may further comprise a first washer which is arranged between the pin head of the connecting pin and the bent, electrically conductive wires. As a result, the pressure from the pin head can be equally distributed over the surface of the first contact component around the hole, whereby a more even contact surface can be achieved between the washer and the wires and/or the contact components, and this in turn reduces the electrical resistance of the points of separation.

According to a further embodiment of the pin connection according to the disclosure, the connecting pin can be a bolt. The connection according to the disclosure is advantageous in particular in the case of screw-in connections, since contact contaminants, which can occur for example by wear of the thread when fitting the bolt in the holes, cannot impair the electrical conductivity of the screw-in connection.

According to a further embodiment of the pin connection according to the disclosure, the pin connection may comprise a nut which is screwed to the bolt on the side of the contact components opposite the pin head of the bolt, wherein the electrically conductive wires are bent in such a way that they are clamped between the nut and the second electrically conductive contact component.

According to a further embodiment of the pin connection according to the disclosure, the pin connection may comprise a second washer which is arranged between the nut and the bent, electrically conductive wires.

According to a further embodiment of the pin connection according to the disclosure, the electrically conductive wires may comprise non-ferrous metals or tin-plated non-ferrous metals.

According to a further embodiment of the pin connection according to the disclosure, the electrically conductive wires may be arranged in a star shape around the centre of the holes.

According to an embodiment of the aircraft or spacecraft according to the disclosure, the aircraft or spacecraft may further comprise an aircraft antenna which is electrically conductively connected to an earthing contact via a pin connection according to the invention. This is particularly advantageous since aircraft antennas are dependent on a low-resistance earthing connection for reliable and long-term functionality.

### BRIEF DESCRIPTION OF THE DRAWINGS

The invention is explained in greater detail in the following by way of embodiments, with reference to the appended figures of the drawings, in which:

FIG. 1 is a schematic view of a hole for a pin connection according to an embodiment;

FIG. 2 is a schematic perspective exploded view of a pin connection according to a further embodiment;

FIG. 3 is a schematic view of a pin connection according to a further embodiment; and

FIG. 4 schematically shows a method for producing a pin connection according to a further embodiment.

The above-described configurations and developments can be combined with one another in any desired manner, within reason. Further possible configurations, developments and implementations of the invention also include not explicitly mentioned combinations of features of the invention which are described above or below in relation to the embodiments.

The appended drawings are intended to facilitate understanding of the embodiments of the invention. They show embodiments and serve, in conjunction with the description, to illustrate principles and approaches of the invention. Other embodiments and many of the advantages mentioned emerge from the drawings. The elements of the drawings are not necessarily shown to scale in relation to one another. In this case, like reference signs denote like or functionally similar components.

### DETAILED DESCRIPTION

Contact components in the context of the present invention include all elements which are in mechanical contact with one another and are interconnected by means of a mechanical connection. In particular, contact components may comprise metal sheets, housing parts, wires, stranded wires, pole shoes, contact discs, strips or similar elements. Contact components in the context of the present invention can in particular be electrically conductive, and in this respect can consist of an electrically conductive material, for example of an metal, such as non-ferrous metals, for example copper, aluminium, nickel, tin or alloys of non-ferrous metals, precious metals, for example gold, silver, platinum, palladium or similar metals, organic substances or carbon fibre composite materials.

Connecting pins in the context of the present invention can comprise all connecting elements which comprise a connecting body which extends between at least two contact components to be connected through appropriate notches provided in the contact components and which provide a mechanically interlocking and, where appropriate, electrical connection between the contact components. In this case, connecting pins can comprise rivets, pins, clamps, nails, bolts, straps, studs, dowel pins, straight pins, tapered pins, grooved pins and similar elements.

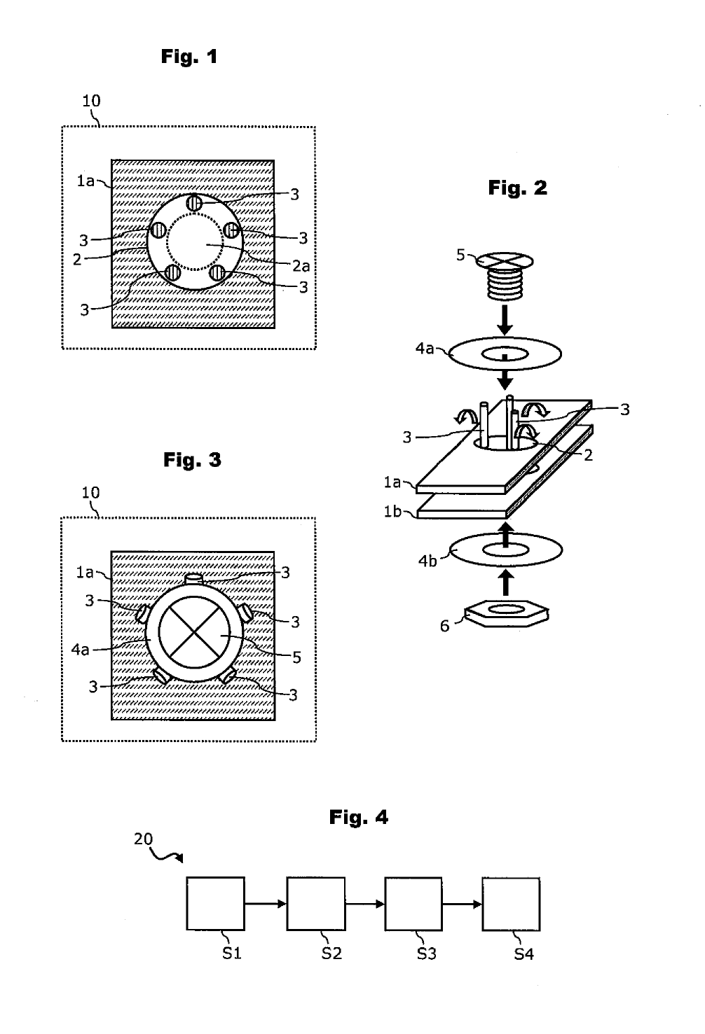

FIG. 1 is a schematic plan view of a hole 2 for a pin connection 10 according to an embodiment. The pin connection 10 can for example be used in an aircraft or spacecraft, in particular when connecting an aeroplane antenna to an earthing contact. Furthermore, the pin connection 10 can be used for example in vehicle manufacture, for example for earth return in electrically operated vehicles.

The pin connection 10 comprises a first electrically conductive contact component 1a, a portion of which is shown in FIG. 1. The first electrically conductive contact component 1 a can be for example a metal sheet or a housing part. A hole 2 is made in the first electrically conductive contact component 1a and extends through the first electrically conductive contact component 1a. The hole 2 can have a round shape; however it may also be possible to provide a polygonal, elliptical or otherwise shaped hole 2.

Electrically conductive wires 3 can be inserted into the hole 2 in such a way that the main extension direction of the wires 3 extends substantially perpendicular to the hole surface of the hole 2. The wires 3 can for example have a cylindrical cross-section and be of any thickness. The number of wires 3 in FIG. 1 is only specified as five by way of example, and it may also be possible to provide more or fewer wires 3. The wires 3 are arranged in the hole 2 in such a way that the wires 3 are located in an outer region of the hole 2, that is to say that an inner region 2a of the hole 2 is not covered by wires 3. The wires 3 can be arranged for example in a star shape around the periphery of the hole 2.

The wires 3 may comprise electrically conductive material, for example non-ferrous metals such as copper, nickel or alloys of non-ferrous metals such as brass. Alternatively, the wires 3 may also comprise non-ferrous metals which have a tin-plated or zinc-plated surface. It should however be clear that the wires 3 can be constructed from other materials which provide the wires 3 with a low specific electrical resistance.

FIG. 2 is a schematic perspective exploded view of a pin connection 10 according to a further embodiment. The pin connection 10 comprises two electrically conductive contact components la and 1 b which are in contact with one another when connected and which comprise holes 2 which can be formed and oriented identically or substantially identically to one another. The penetration surfaces of the holes 2 may in this case for example be congruent with one another. Electrically conductive wires 3 are placed in the holes 2, as is described in conjunction with FIG. 1.

A connecting pin 5, for example a bolt 5, can now be guided through the hole 2 or holes 2. In this case, the connecting pin 5 fits the hole 2 or holes 2 in such a way that the connecting pin 5 is located in the inner region 2a of the holes 2 and the wires 3 are arranged between the edges of the holes 2 and the connecting pin 5.

The connecting pin 5 comprises a pin head, for example a bolt head, which has a larger diameter than the connecting body. When the connecting pin 5 is inserted into the holes 2, the ends of the wires 3 pointing towards the pin head, which wires project from the hole 2, are pressed radially outwards relative to the hole 2 by means of the pin head, as shown by way of example by the arrows in FIG. 2. In this case, the pin head is pressed against the upper contact component 1a in such a way that the bent ends of the wires 3 are clamped between the pin head of the connecting pin 5 and the contact component 1a.

The ends of the wires 3 can be deformed by pressure on the connecting pin 5, in such a way that the material of the wires 3 on the underside of the pin head and the contact surface fits around the hole of the first contact component 1a. As a result, the effective contact surface between the connecting pin 5 and the contact component 1a is enlarged. In the case of corresponding conductivity of the wires 3, low-resistance electrical contact can be thus provided between the contact component 1a and the connecting pin 5. In addition, it can be provided that, if there is a sufficiently large amount of wires 3 or corresponding dimensions of the hole 2 and thickness of the wires 3, the hole can be hermetically sealed against the outside environment by means of the clamped wires 3. As a result, foreign particles such as dust or dirt can no longer penetrate the hole and impair the electrical conductivity.

As shown in FIG. 2, it can be provided for a first washer 4a to be placed between the connecting pin 5 and the first contact component 1a, which washer is arranged between the wires and the pin head. By means of the washer 4a, the connecting force exerted by the pin head can be distributed more extensively and uniformly over the first contact component 1a, and this improves the reliability of the electrical connection.

If a bolt 5 is used as a connecting pin 5, a nut 6 having a corresponding second washer 4b can be screwed to the bolt 5 from the opposite side. In this case, the second washer 4b bends the ends of the wires 3 which point downwards, as described above, radially outwards relative to the hole 2 and clamps the wires between itself and the second contact component 1b.

FIG. 3 is a schematic view of a pin connection 10 according to a further embodiment, for example a pin connection 10 such as that shown in FIG. 2. The connecting pin 5 presses on the first washer 4a, which in turn clamps the wires 3 or the ends of the wires which are bent radially outwards between itself and the first contact component 1a. In this case, the ends of the wires can, as shown in FIG. 3, project onto the first contact component 1a under the projection surface of the washer 4a, or can be trimmed around the circumference of the first washer 4a.

FIG. 4 schematically shows a method 20 for producing a pin connection, for example in an aircraft or spacecraft, in particular for producing a pin connection 10 shown by way of example with respect to FIGS. 2 to 3.

At S1, a first electrically conductive contact component, which comprises a first hole, is arranged so as to be in contact with a second electrically conductive contact component, which comprises a second hole which is congruent with the first hole. At S2, a plurality of electrically conductive wires are inserted into the holes at the edges of the holes. At S3, a connecting pin, which comprises a pin head, is guided through the first and the second holes for connecting the first electrically conductive contact component and the second electrically conductive contact component, wherein the electrically conductive wires are bent in such a way that they are clamped between the pin head of the connecting pin and the first electrically conductive contact component. Optionally, at S4, a first washer can be placed under the pin head of the connecting pin, in such a way that the first washer is arranged between the pin head of the connecting pin and the bent, electrically conductive wires.

Although the present invention has presently been described on the basis of preferred embodiments, it is in no way restricted thereto, but can be modified in many different ways.

What is claimed is:

1. An electrically conductive pin connection, comprising:
a first electrically conductive contact component which comprises a first hole;
a second electrically conductive contact component which is in contact with the first electrically conductive contact component and which comprises a second hole;
a connecting pin which comprises a pin head and which is guided through the first and second holes for connecting the first electrically conductive contact component and the second electrically conductive contact component; and
a plurality of electrically conductive wires which are arranged in the holes between the edges of the holes and the connecting pin, wherein the electrically conductive wires are bent in such a way that they are clamped between the pin head of the connecting pin and the first electrically conductive contact component.

2. The pin connection according to claim 1, further comprising:
a first washer which is arranged between the pin head of the connecting pin and the bent, electrically conductive wires.

3. The pin connection according to claim 1, wherein the connecting pin is a bolt.

4. The pin connection according to claim 3, further comprising:
a nut which is screwed to the bolt on the side of the contact components opposite the pin head of the bolt, wherein the electrically conductive wires are bent in such a way that they are clamped between the nut and the second electrically conductive contact component.

5. The pin connection according to claim 4, further comprising:
a second washer which is arranged between the nut and the bent, electrically conductive wires.

6. The pin connection according to claim 1, wherein the electrically conductive wires comprise non-ferrous metals or tin-plated non-ferrous metals.

7. The pin connection according to claim 1, wherein the electrically conductive wires are arranged in a star shape around the centre of the holes.

8. An aircraft or spacecraft comprising at least one pin connection according to claim 1.

9. The aircraft or spacecraft according to claim 8, further comprising:
an aircraft antenna which is electrically conductively connected to an earthing contact via a pin connection according to claim 1.

10. A method for producing a pin connection, comprising:
arranging a first electrically conductive contact component, which comprises a first hole, so as to be in contact with a second electrically conductive contact component, which comprises a second hole which is congruent with the first hole;
inserting a plurality of electrically conductive wires into the holes at the edges of the holes; and
guiding a connecting pin, which comprises a pin head, through the first and the second holes for connecting the first electrically conductive contact component and the second electrically conductive contact component, wherein the electrically conductive wires are bent in such a way that they are clamped between the pin head of the connecting pin and the first electrically conductive contact component.

11. The method according to claim 10, further comprising:
placing a first washer under the pin head of the connecting pin, in such a way that the first washer is arranged between the pin head of the connecting pin and the bent, electrically conductive wires.
